(19) United States
(12) Patent Application Publication
(10) Pub. No.: US 2022/0055028 A1
(43) Pub. Date: Feb. 24, 2022

(54) FLUID HANDLING SYSTEM

(71) Applicant: Enplas Corporation, Saitama (JP)

(72) Inventors: Ken KITAMOTO, Saitama (JP); Koji MURAKI, Saitama (JP); Yuya OSHIMA, Saitama (JP)

(73) Assignee: Enplas Corporation, Saitama (JP)

(21) Appl. No.: 17/298,988

(22) PCT Filed: Nov. 20, 2019
(86) PCT No.: PCT/JP2019/045480

§ 371 Date: Jun. 2, 2021

(30) Foreign Application Priority Data
Dec. 3, 2018 (JP) 2018-226560

(51) Int. Cl. B01L 3/02; B01L 3/00

(52) U.S. Cl. CPC B01L 3/0293; B01L 3/502715; B01L 2300/042; B01L 2200/16; B01L 2200/0605

(57) ABSTRACT

The present invention addresses the problem of providing a fluid handling system that is capable of injecting a fluid into a desired chip or the like without using a large-scale device. In order to resolve the problem, this fluid handling system has a reservoir, a flow path chip, and a cap, one end of which is fitted to the internal opening of the reservoir and the other end of which is connected to an introduction port of the flow path chip, the cap having a through-hole that links the one end and the other end. In this fluid handling system, a protruding part provided to the flow path chip is fitted into the through-hole at the other end of the cap and restricts blocking of the through-hole when a fluid moves inside the through-hole of the cap.

### TECHNICAL FIELD

The present invention relates to a fluid handling system.

### BACKGROUND ART

In the related art, when testing or analyzing various fluids, it has been common practice to dispense the required amount of sample from the container used to store the fluid (sample) using a pipette, etc., and inject the sample into a chip or device for analysis. In the related art, devices that can automatically dispense samples by pipette and inject samples into chips have been proposed (e.g., PTL 1 and PTL 2).

### CITATION LIST

### Patent Literature

### PTL 1

### Japanese Patent Application Laid-Open No. 2013-150634

### PTL 2

### WO2013/088913

### SUMMARY OF INVENTION

### Technical Problem

However, the analyzers described in PTL 1 and PTL 2 required a separate means for aspirating the sample into the pipette and for moving the pipette. In addition, a plurality of pipettes was needed to inject multiple samples and reagents into the chip or device, and these also needed to be controlled. As a result, the device tends to be large and costly.

In view of the above, an object of the present invention is to provide a fluid handling system that can reliably inject fluid to the desired channel chip without using a large device.

### Solution to Problem

The present invention provides the following fluid handling system.

A fluid handling system including a reservoir including a housing part configured to house fluid and an opening disposed in a side surface or a bottom surface of the housing part, the opening being configured to communicate between the housing part and outside; a channel chip disposed opposite to the opening of the reservoir, the channel chip including an inlet configured to introduce the fluid, a channel configured to carry the fluid introduced from the inlet, and a protruding part disposed to surround an opening edge of the inlet; and a cap made of a flexible elastomer and including one end configured to be fit into the opening of the reservoir, another end configured to be connected to the inlet of the channel chip, and a through hole configured to connect the one end and the other end, wherein when the opening of the reservoir presses one end side of the cap such that the through hole is closed, a closed state is set, the closed state being a state where the fluid in the housing part does not move to outside through the through hole of the cap, wherein when the one end side of the cap is moved from the closed state to a side of the housing part of the reservoir or to a side of the channel chip, pressing on the cap at the opening is released, and an opened state is set, the opened state being a state where the fluid moves to the side of the housing part of the reservoir toward the inlet of the channel chip through the through hole, and wherein in the opened state, the protruding part of the channel chip is fit to the through hole on a side of the other end of the cap and suppresses closing of the through hole.

### Advantageous Effects of Invention

According to the present invention, it is possible to provide a fluid handling system that can inject fluid into a channel chip in a simple method without using a means for driving a pipette or a means for convey chips.

### BRIEF DESCRIPTION OF DRAWINGS

FIG. 1 is an exploded perspective view of a fluid handling system according to a first embodiment of the present invention;

FIG. 2A is a sectional view of the fluid handling system illustrated in FIG. 1 taken along the A-A direction with the fluid handling system in a closed state, and FIG. 2B is a sectional view of the fluid handling system illustrated in FIG. 1 taken along the B-B direction with the fluid handling system in a closed state;

FIG. 3A is a sectional view of the fluid handling system illustrated in FIG. 1 taken along the A-A direction with the fluid handling system in an opened state, and FIG. 3B is a sectional view of the fluid handling system illustrated in FIG. 1 taken along B-B direction with the fluid handling system in an opened state;

FIG. 4A is a front view of a reservoir provided in the fluid handling system according to the first embodiment, FIG. 4B is a plan view of the reservoir, FIG. 4C is a bottom view of the reservoir, and FIG. 4D is a side view of the reservoir;

FIG. 5A is a sectional view of the reservoir illustrated in FIG. 4C taken along line A-A, FIG. 5B is a sectional view of the reservoir illustrated in FIG. 4C taken along line B-B, FIG. 5C is a partially enlarged view of the region surrounded by the broken line in FIG. 4C, and FIG. 5D is a partially enlarged view of the region surrounded by the broken line in FIG. 4B;

FIG. 6A is a perspective view of a top surface side of a cap of provided in the fluid handling system according to the first embodiment, FIG. 6B is a perspective view of a bottom surface side of the cap, FIG. 6C is a front view of the cap, FIG. 6D is a plan view of the cap, FIG. 6E is a sectional view of the cap illustrated in FIG. 6D taken along line A-A, and FIG. 6F is a sectional view of the cap illustrated in FIG. 6D taken along line B-B;

FIG. 7A is a schematic sectional view of a microchannel chip provided in the fluid handling system according to the first embodiment, and FIG. 7B is a partially enlarged view of the region surrounded by the broken line in FIG. 7A;

FIG. 8 is a bottom view of a body part of the microchannel chip provided in the fluid handling system according to the first embodiment;

FIG. 9 is a partially enlarged view of the region surrounded by the broken line in FIG. 3B;

FIG. 10A is a schematic sectional view of a modification of the microchannel chip of the fluid handling system according to the first embodiment, and FIG. 10B is a partially enlarged view of a region surrounded by the broken line in FIG. 10A; and

FIG. 11A is a schematic sectional view of a fluid handling system according to a second embodiment with the fluid handling system in an opened state, and FIG. 11B is a partially enlarged view of the region surrounded by the broken line in FIG. 11A with the fluid handling system in an opened state.

### DESCRIPTION OF EMBODIMENTS

A fluid handling system according to the embodiment of the present invention is elaborated below with reference to the accompanying drawings. Note that the dimensions or proportions of dimensions shown in the drawings may differ from the actual dimensions or proportions of dimensions for clarity of explanation.

### First Embodiment

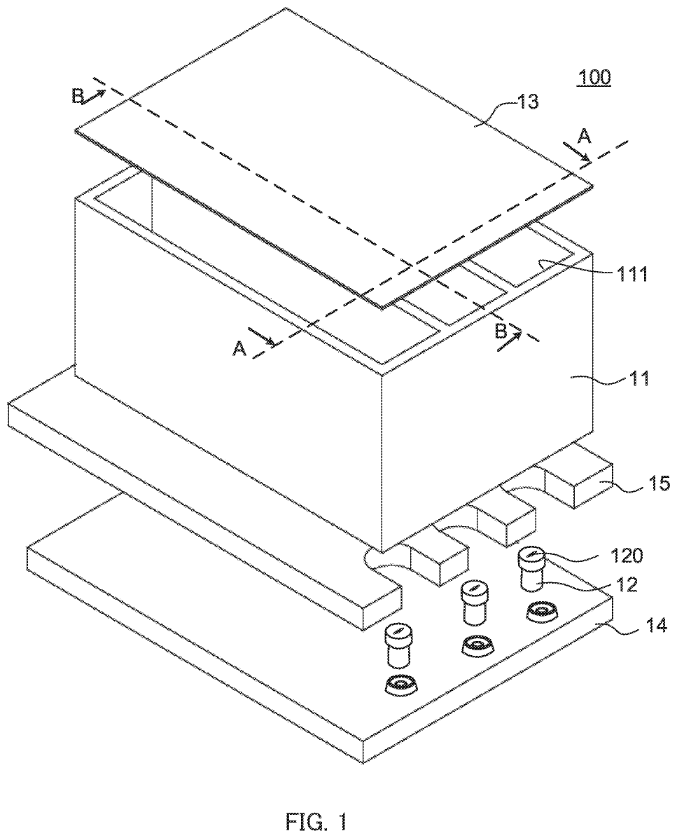

As illustrated in the exploded perspective view of FIG. 1, fluid handling system 100 according to a first embodiment of the present invention includes reservoir 11 configured to house fluid, microchannel chip 14 disposed below the reservoir 11 in the gravity direction, spacer 15 disposed between the reservoir 11 and microchannel chip 14, cap 12 having one end that is fitted to an opening (not illustrated) of reservoir 11 and the other end that is connected to an inlet (not illustrated) of microchannel chip 14, and lid 13 that covers reservoir 11. It should be noted that the fluid handling system 100 may be distributed in the state where each of reservoir 11, cap 12, lid 13, microchannel chip 14, and spacer 15 is detached. In addition, fluid handling system 100 of the present embodiment may not include spacer 15 as long as cap 12 can be prevented from being pushed into housing part 111 side of reservoir 11 when storing fluid into housing part 111 of reservoir 11.

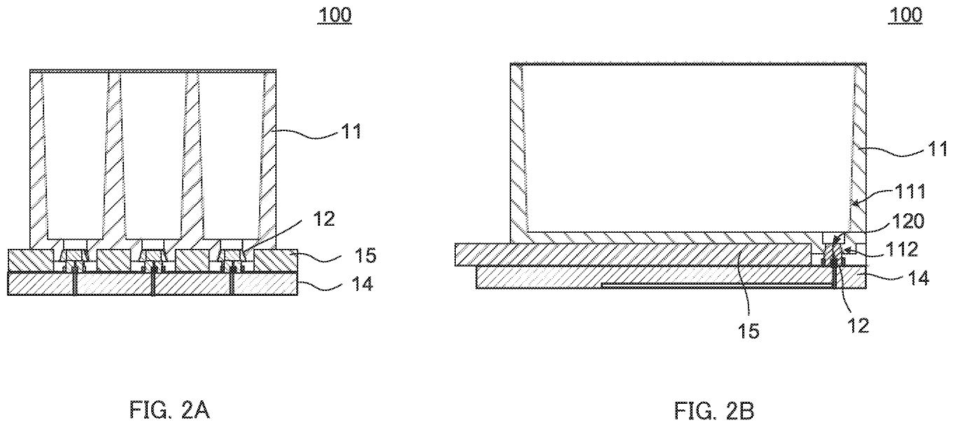

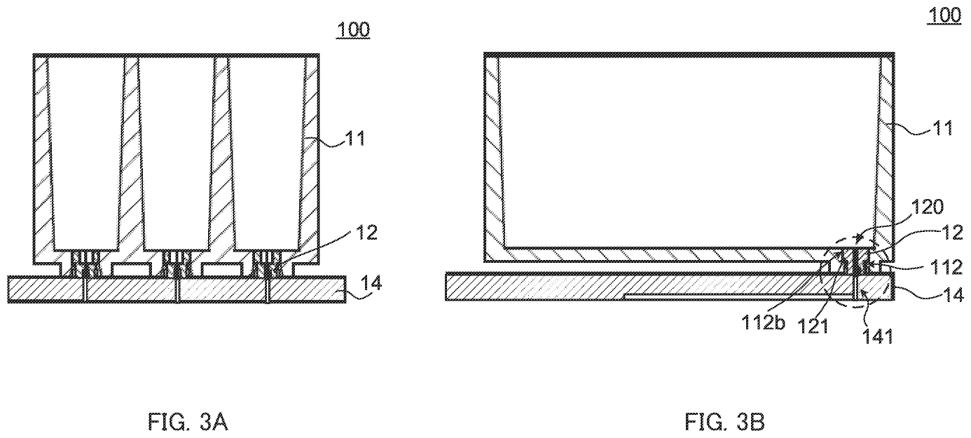

FIGS. 2A and 2B are schematic sectional views of a state when fluid is stored in housing part 111 of reservoir 11 (in the specification, this state is referred to also as “closed state” of fluid handling system 100) in the fluid handling system 100, i.e., when spacer 15 is disposed between it and microchannel chip 14. FIGS. 3A and 3B are schematic sectional views of a state when cap 12 is moved to housing part 111 side of reservoir 11 from an opened state (in the specification, in this state is referred to also as “opened state” of fluid handling system 100), i.e., when spacer 15 is removed from the fluid handling system 100. Note that FIGS. 2A and 3A are sectional views taken along A-A direction in FIG. 1. FIGS. 2B and 3B are sectional views taken along B-B direction in FIG. 1.

As illustrated in FIGS. 2A and 2B, in fluid handling system 100 of the present embodiment, when spacer 15 is disposed between reservoir 11 and microchannel chip 14, opening 112 of reservoir 11 presses cap 12 and closes through hole 120 of cap 12. That is, cap 12 functions as a stopper of reservoir 11.

On the other hand, as illustrated in FIGS. 3A and 3B, when spacer 15 is removed and the end portion of cap 12 on reservoir 11 side (in the specification, also referred to as “one end”) is moved to housing part 111 side, the pressing on cap 12 at opening 112 of reservoir 11 is released. As a result, through hole 120 of cap 12 is reset to the original shape, and the through hole 120 serves as a channel that connects housing part 111 of reservoir 11 and inlet 141 of microchannel chip 14.

Each member of fluid handling system 100 of the present embodiment is elaborated below.

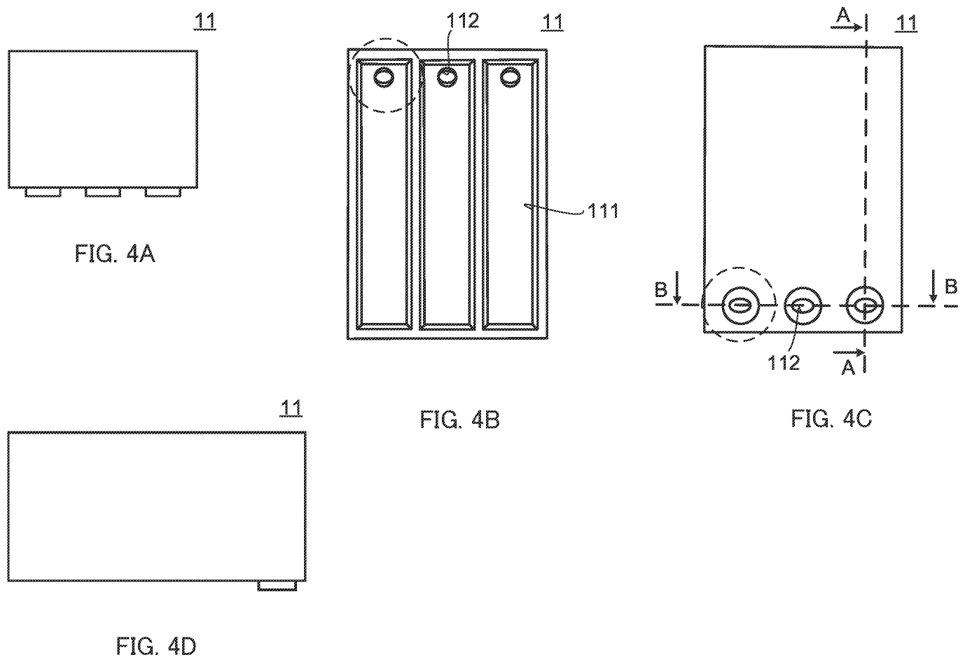

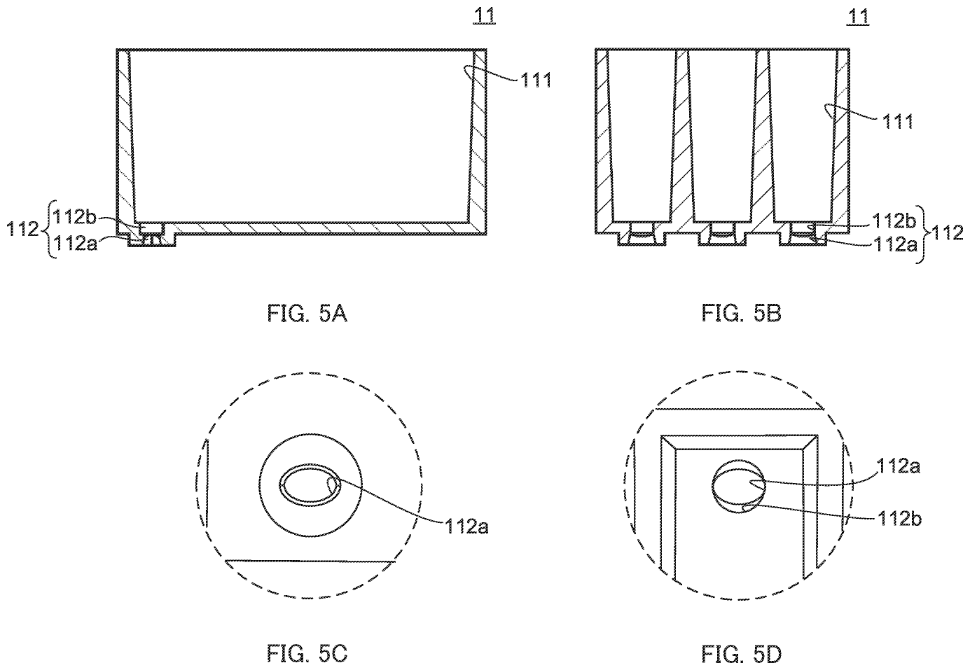

FIG. 4A is a front view of reservoir 11, FIG. 4B is a plan view, FIG. 4C is a bottom view, and FIG. 4D is a side view. In addition, FIG. 5A is a sectional view of reservoir 11 illustrated in FIG. 4C taken along line A-A, FIG. 5B is a sectional view of reservoir 11 illustrated in FIG. 4C taken along line B-B, FIG. 5C is a partially enlarged view of the portion surround by broken line in FIG. 4C, and FIG. 5D is a partially enlarged view of the portion surround by broken line in FIG. 4B.

Reservoir 11 of the present embodiment includes three housing parts 111, and three openings 112 disposed in the bottom portions of respective housing parts 111. The shape of reservoir 11 is not limited as long as the desired amount of fluid can be contained in housing part 111, and may be, for example, a substantially cuboid shape, columnar shape or the like. Note that the numbers of housing parts 111 and openings 112 disposed in reservoir 11 are not limited, and may be appropriately selected in accordance with the use of fluid handling system 100. For example, a plurality of openings 112 may be disposed in one housing part 111. In addition, while three housing parts 111 have the same shape and three openings 112 have the same shape in the present embodiment, they may have shapes different from each other.

Housing part 111 of reservoir 11 in the present embodiment is a bottomed recess with a substantially cuboid shape. It should be noted that the shape of housing part 111 is not limited as long as the desired amount of fluid can be contained, and may be various shapes such as a truncated pyramid shape, a columnar shape, a truncated cone shape or the like, for example. In addition, while the bottom surface of housing part 111 is set to be approximately parallel to the surface of the fluid housed therein in the present embodiment, a part or the entirely of the bottom surface may be tilted downward in the gravity direction toward opening 112 side.

On the other hand, opening 112 is a hole that communicates between the inside of housing part 111 and the outside of reservoir 11. In the present embodiment, opening 112 is disposed to partially protrude from the bottom surface of reservoir 11 to the lower side in the gravity direction.

Here, as illustrated in FIGS. 5A to 5D, opening 112 includes pressing region 112a disposed on the outside in reservoir 11 and including an opening with a substantially elliptical columnar shape, and open region 112b disposed on housing part 111 side in reservoir 11 and including an opening with a substantially columnar shape.

Pressing region 112a is a region for closing through hole 120 by pressing a part of cap 12 toward the central axis thereof when setting fluid handling system 100 to the closed state. The opening shape of pressing region 112a is a substantially elliptical columnar shape. The shape of cap 12 is a substantially columnar shape as described later. Therefore, when cap 12 is inserted into pressing region 112a, the exterior wall of pressing region 112a presses a part of cap 12 toward the central axis thereof. Then, through hole 120 of cap 12 is closed, and the discharge of the fluid is suppressed.

It suffices that pressing region 112a has a shape with which at least a part of through hole 120 of cap 12 can be closed when cap 12 is inserted, and may be, for example, a region with an opening cross sectional area that is uniform in the direction from the outside of reservoir 11 toward open region 112b side. It should be noted that in the present embodiment, it has a tapered shape whose opening cross sectional area decreases in the direction from the outside of reservoir 11 toward open region 112b side for the sake of easy insertion of cap 12 to pressing region 112a.

On the other hand, open region 112b is a region for preventing through hole 120 of cap 12 from being closed when setting fluid handling system 100 to an opened state. In the present embodiment, the opening cross sectional area of open region 112b is greater than the opening cross sectional area of pressing region 112a such that the force exerted in the central axis direction of cap 12 is reduced and the shape of through hole 120 is easily returned to the original shape.

In addition, in the present embodiment, the opening shape of open region 112b is a shape (columnar shape) similar to the external shape of the region of cap 12 on housing part 111 side (the first region of cap 12 described later). When columnar cap 12 is housed in columnar open region 112b, cap 12 is returned to the original columnar shape. Thus, through hole 120 can open and fluid can move in through hole 120 of cap 12.

It should be noted that when a gap is formed between open region 112b and the first region of cap 12, the fluid may be leaked to the outside of housing part 111 through the gap. In view of this, in the present embodiment, the opening diameter (diameter) of open region 112b is set to a diameter equal to smaller than the diameter of the columnar first region of cap 11.

Here, reservoir 11 including housing part 111 and opening 112 may be made of resin that is not eroded by the fluid housed in housing part 111. Examples of the material of reservoir 11 include: polyester such as polyethylene terephthalate; polycarbonate; acrylic resin such as polymethylmethacrylate; polyvinyl chloride; polyolefin such as polyethylene, polypropylene, and cycloolefin resin; polyether; polystyrene; silicone resin; and resin materials such as various elastomers. In addition, the above-mentioned reservoir 11 can be formed by injection molding and the like, for example.

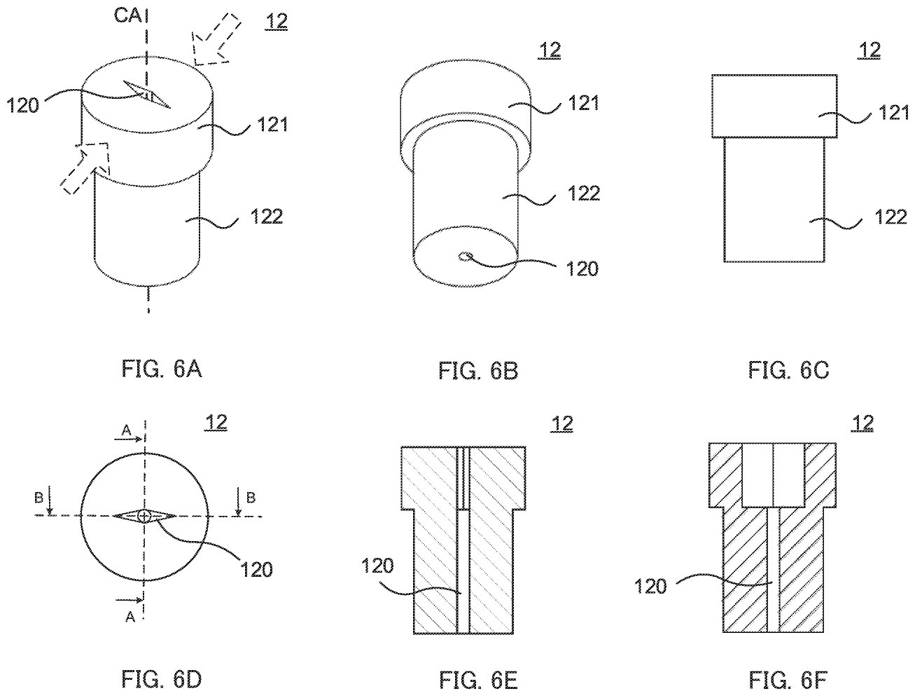

FIG. 6A is a perspective view illustrating a top surface side of cap 12 of the present embodiment, and FIG. 6B is a perspective view illustrating a bottom surface side. In addition, FIG. 6C is a front view of the cap 12, and FIG. 6D is a plan view. Note that FIG. 6E is a sectional view of cap 12 illustrated in FIG. 6D taken along line A-A, and FIG. 6F is a sectional view of cap 12 illustrated in FIG. 6D taken along line B-B.

Cap 12 of the present embodiment has a substantially columnar shape, and includes through hole 120 approximately parallel to its central axis CA. The cap 12 includes columnar first region 121 that is pressed by the exterior wall of opening 112 (pressing region 112a) such that through hole 120 is closed when housed in pressing region 112a of opening 112 of reservoir 11, and columnar second region 122 whose cross-sectional area in the direction orthogonal to the central axis of cap 12 is smaller than the first region 121. They are coupled at the bottom surface of first region 121 and the top surface of second region 122.

The diameter (outer diameter) of first region 121 is appropriately set in accordance with the opening width and/or opening cross sectional area of opening 112 of reservoir 11 (pressing region 112a and open region 112b). In addition, the height of first region 121 is not limited, and is appropriately selected in accordance with the shape of opening 112 of reservoir 11 (pressing region 112a and open region 112b). In the present embodiment, the height is set such that the end portion of cap 12 on first region 121 side does not protrude into housing part 111 in the opened state of fluid handling system 100, i.e., when first region 121 is housed in open region 112b of reservoir 11. That is, the height of first region 121 of cap 12 is set to a height equal to or smaller than the height of open region 112b of opening 112 of reservoir 11. By setting the height of first region 121 of cap 12 in the above-mentioned manner, when fluid handling system 100 is set to the opened state, cap 12 does not protrude into housing part 111 and the fluid easily flow into through hole 120 of cap 12.

In addition, the opening shape of through hole 120 in first region 121 in the direction orthogonal to central axis CA is not limited as long as it is closed with no gap when first region 121 is housed in pressing region 112a of reservoir 11, and may be a slit shape, for example. The “slit shape” as used herein means a gap that is long in one direction in a cross-section perpendicular to central axis CA of cap 12, and is closed into a linear shape when pressed from both sides along the minor axis direction. In the present embodiment, as illustrated in FIG. 6A, the shape of through hole 120 in a direction perpendicular to central axis CA is a rhombic shape with one diagonal sufficiently longer than the other diagonal. The width of the slit is appropriately selected based on the type of the fluid and/or the desired fluid flow rate.

On the other hand, the diameter (outer diameter) of second region 122 is appropriately set in accordance with the width and/or opening cross sectional area of pressing region 112a of opening 112 of reservoir 11. In addition, the height of second region 122 is not limited. In the present embodiment, the height of second region 122 of cap 12 and the height of pressing region 112a of opening 112 of reservoir 11 are substantially equal to each other.

In addition, the opening shape of through hole 120 of second region 122 in a direction perpendicular to central axis CA is appropriately selected in accordance with the fluid type, the desired fluid flow rate, and the shape of protruding part of microchannel chip 14 described later. The opening shape of through hole 120 in the second region 122 may be the same as or different from the shape of through hole 120 of first region 121. In the present embodiment, the shape of through hole 120 of second region 122 in a direction perpendicular to central axis CA is a circular shape.

Here, it suffices that cap 12 is composed of a material having flexibility, and may be composed of a publicly known elastomer. Elastomer resin includes thermoplastic resin and thermosetting resin, and cap 12 may be composed of any of them. Examples of the thermosetting elastomer resin that can be used for cap 12 include polyurethane based resin and poly silicone based resin, and examples of the thermoplastic elastomer resin include styrene based resin, olefin based resin and polyester based resin. Specific examples of the olefin based resin include polypropylene resin. In addition, first region 121 and second region 122 of cap 12 may be composed of the same material, or different materials. It should be noted that the same material is preferable from a view point of the ease of manufacture and the like. In addition, cap 12 can be formed by injection molding and the like, for example.

In addition, lid 13 in fluid handling system 100 is not limited as long as it can suppress leakage of fluid from the top surface side of housing part 111 when fluid is housed in housing part 111 of reservoir 11. Lid 13 may have a structure that is detachable to reservoir 11, or may be a film the like bonded to reservoir 11. For example, lid 13 may be bonded to reservoir 11 with an adhesive agent (such as a hot-melt adhesive and a pressure-sensitive adhesive).

It suffices that lid 13 is a film composed of a material that is not eroded by the above-described fluid, and its thickness and the like are appropriately selected. Examples of the material of lid 13 include polyester such as polyethylene terephthalate; polycarbonate; acrylic resin such as polymethylmethacrylate; polyvinyl chloride; polyolefin such as polyethylene, polypropylene, and cycloolefin resin; polyether;

polystyrene; silicone resin; resin materials such as various elastomers; and metal such as aluminum.

Lid 13 may include a partial opening, and a cap similar to the above-described cap may be disposed at the opening. The shape of the opening of lid 13 may be the same as the shape of the opening of reservoir 11. The opening that can be opened and closed by the cap in lid 13 may be utilized as an air hole, an introduction part for supplying reagent to the reservoir and the like.

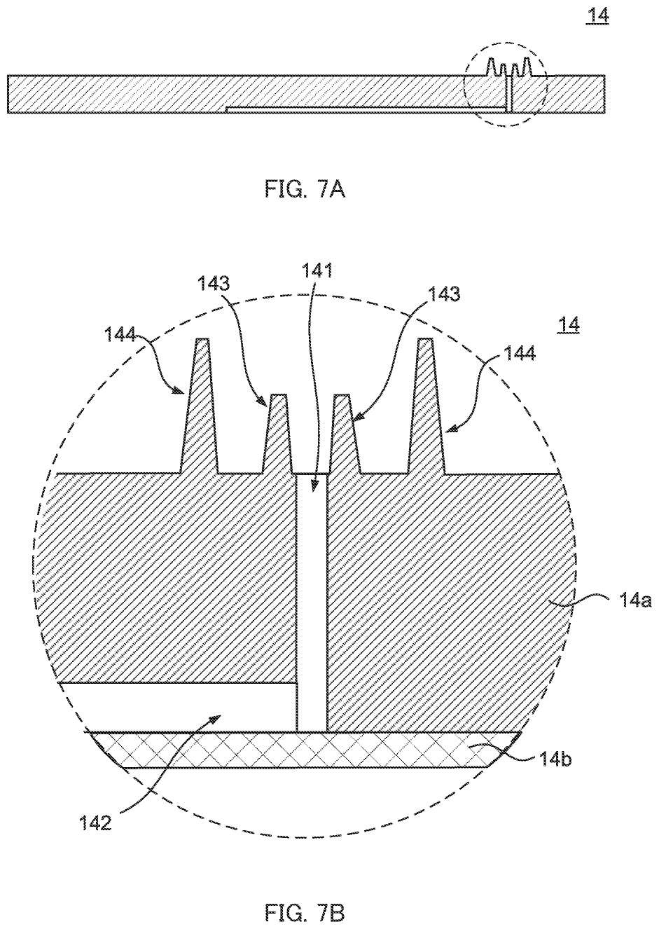

FIG. 7A is a schematic sectional view of microchannel chip 14 of the present embodiment taken along line B-B of FIG. 1, and FIG. 7B is an enlarged view of the portion surround by the broken line in FIG. 7A. As illustrated in FIG. 7B, microchannel chip 14 of the present embodiment includes inlet 141 for introducing the fluid, channel 142 for carrying the fluid introduced from inlet 141, an outlet (not illustrated) for discharging the fluid, protruding part 143 disposed to surround the opening edges of inlet 141 and the outlet, and guide part 144 disposed outside the protruding part 143. In addition, as illustrated in FIG. 7B, microchannel chip 14 is composed of body part 14a and film 14b bonded to one surface of the body part.

Inlet 141 and the outlet (not illustrated) are through holes provided in body part 14a. The opening diameter of inlet 141 and/or the outlet is not limited as long as the fluid can move at the desired speed, and, in the present embodiment, the opening diameter is set to a value smaller than the opening diameter of the end portion of cap 12 on microchannel chip 14 side by the thickness of protruding part 143.

On the other hand, channel 142 is the region surrounded by film 14b and the groove disposed on body part 14a side to connect inlet 141 and the outlet. The width and/or depth of the channel 142 is not limited as long as the fluid can move at the desired speed.

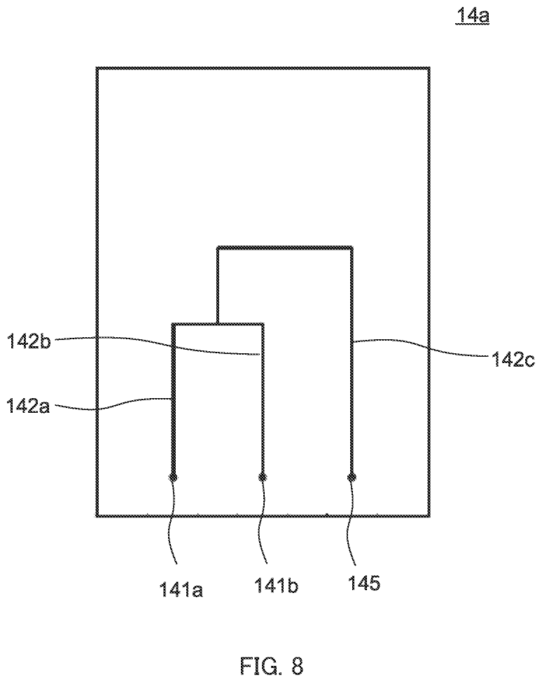

Here, the shape of channel 142 in microchannel chip 14, and the position of inlet 141 and/or the outlet 145 are appropriately selected in accordance with the type and/or use of microchannel chip 14. FIG. 8 is a bottom view of body part 14a of microchannel chip 14. The body part 14a of microchannel chip 14 is provided with first inlet 141a and second inlet 141b for introducing the fluid, outlet 145 for discharging the fluid from microchannel chip 14, and first groove part 142a, second groove part 142b, and third groove part 142c for connecting them. In the microchannel chip 14, the region surrounded by the film and first groove part 142a is the first channel, the region surrounded by the film and second groove part 142b is the second channel, and the region surrounded by the film and third groove part 142c is the third channel.

In microchannel chip 14 having the above-mentioned structure, for example, the first fluid (in the present embodiment, the sample) is introduced from first inlet 141a, and the second fluid (in the present embodiment, the reagent) is introduced from second inlet 141b. Then, these fluids are carried into the third channel through the first channel and the second channel, so as to cause a reaction at the third channel. Thereafter, the reactant can be moved from outlet 145 into housing part 111 of reservoir 11 through cap 12, for example.

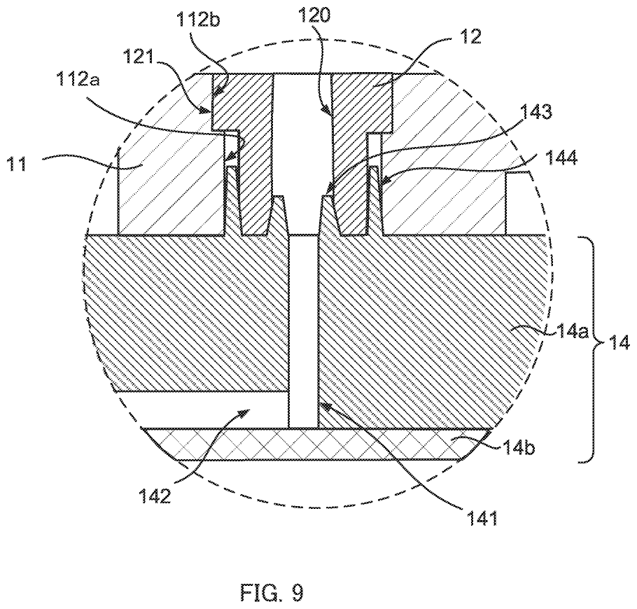

On the other hand, protruding part 143 of microchannel chip 14 is disposed to surround the opening edges of inlet 141 and the outlet in the surface opposite to reservoir 11 in body part 14a. Protruding part 143 is fit into through hole 120 of cap 12 when setting fluid handling system 100 to the opened state, and thus suppresses the close of through hole 120 on microchannel chip 14 side. FIG. 9 is an enlarged view of the region surrounded by the broken line in FIG. 3B.

The shape of the protruding part 143 is not limited as long as, when setting fluid handling system 100 to an opened state, the close of through hole 120 of cap 12 can be suppressed, and the movement of the fluid from through hole 120 side of cap 12 toward inlet 141 side of microchannel chip 14 is not blocked. In the present embodiment, protruding part 143 is a circular protrusion protruded from the surface of microchannel chip 14 on reservoir 11 side. It should be noted that protruding part 143 may not be formed to surround the whole circumference of the opening edges of inlet 141 and/or the outlet 145, and a cutout may be formed in a part of the circular part, for example.

In addition, preferably, from a view point of not interfering the fluid flow, the internal diameter of the protruding part 143 is close to the opening diameter of through hole 120 of cap 12, and the opening diameter of inlet 141 and the outlet of microchannel chip 14. In the present embodiment, it is substantially equal to the opening diameter of inlet 141 and the outlet. Note that the internal diameter of protruding part 143 increases in the direction away from inlet 141 and/or the outlet 145 in the present embodiment, but the internal diameter of protruding part 143 may be constant.

In addition, in the present embodiment, the outer diameter of the protruding part 143 is substantially equal to the opening diameter of through hole 120 of cap 12. It should be noted that for preventing leakage of fluid and making protruding part 143 less removal from through hole 120, the outer diameter of protruding part 143 may be greater than the opening diameter of through hole 120.

On the other hand, guide part 144 of microchannel chip 14 is disposed on the outer periphery side of the above-described circular protruding part 143 in the surface of body part 14a opposite to reservoir 11. Guide part 144 is a structure for guiding, to inlet 141 and/or outlet side of microchannel chip 14, an end portion of cap 12 on microchannel chip 14 side (in the specification, also referred to as “the other end”). When microchannel chip 14 is provided with guide part 144, the ease of the alignment for fitting the above-described protruding part 143 into through hole 120 of cap 12 increases. In addition, deformation of cap 12 on microchannel chip 14 side is further easily suppressed. Further, since the other end side of cap 12 is sandwiched between protruding part 143 and guide part 144, protruding part 143 is less removal from through hole 120 even when the pressure in through hole 120 increases.

The shape of the guide part 144 is not limited. In the present embodiment, it is a circular protrusion protruding concentrically with protruding part 143 from the surface of microchannel chip 14 on reservoir 11 side, but a cutout may be formed in a part of the circular part.

The internal diameter of the guide part 144 is substantially equal to the outer diameter of second region 122 of cap 12 from the view point of smoothly guiding the other end of cap 12 to inlet 141 side and further making cap 12 less removal. Note that the internal diameter of guide part 144 increases in the direction away from inlet 141 and/or the outlet in the present embodiment, but the internal diameter of guide part 144 may be constant. In addition, the height and outer diameter of guide part 144 are not limited. It should be noted that in the present embodiment, reservoir 11 (the inner wall of pressing region 112a of opening 112) is disposed outside guide part 144 when setting fluid handling system 100 to the opened state as illustrated in FIG. 9, but guide part 144 and opening 112 of reservoir 11 may not make contact with each other. In the present embodiment, the outer diameter of guide part 144 is smaller than the opening diameter of pressing region 112a of opening 112 of reservoir 11.

Note that examples of the material of body part 14a include polyester such as polyethylene terephthalate; polycarbonate; acrylic resin such as polymethylmethacrylate; polyvinyl chloride; polyolefin such as polyethylene, polypropylene, and cycloolefin resin; polyether; polystyrene; silicone resin; and resin materials such as various elastomers. In addition, body part 14a having the above-mentioned configurations may be formed by injection molding and the like, for example.

Here, body part 14a may be or may not be optically transparent. For example, in the case where fluid is observed from the surface on the side opposite to the front surface of body part 14a, the material is selected such that body part 14a is optically transparent.

On the other hand, film 14b may be a flat film that covers body part 14a. It suffices that the film is composed of a material that is not eroded by the fluid introduced in microchannel chip 14, and the thickness of the film and the like are appropriately selected. Examples of the material of the film include polyester such as polyethylene terephthalate; polycarbonate; acrylic resin such as polymethylmethacrylate; polyvinyl chloride; polyolefin such as polyethylene, polypropylene, and cycloolefin resin; polyether; polystyrene; silicone resin; and resin materials such as various elastomers.

In the case where observation and/or analysis of fluid is performed from the film side in the state where fluid is housed in third channel, the material of the film is selected such that the film is optically transparent. Note that in the case where fluid is observed from the surface on the side opposite to the front surface of body part 14a, or the observation of the fluid is not performed and the like, film 14b may not be optically transparent.

In addition, body part 14a and film 14b may be joined by a publicly known method such as heat fusing, bonding with an adhesive agent or the like.

On the other hand, spacer 15 in fluid handling system 100 is a member for keeping first region 121 of cap 12 not being pushed to open region 112b side of opening 112 of reservoir 11 when setting fluid handling system 100 to the closed state with a sufficient distance between reservoir 11 and microchannel chip 14.

It suffices that the spacer 15 is detachably disposed to fluid handling system 100, and in the present embodiment, it is a comb-shaped member that can be inserted between reservoir 11 and microchannel chip 14 from one direction. It should be noted that the shape of spacer 15 is not limited to the above-mentioned shape. In addition, spacer 15 is disposed in the majority of the region where reservoir 11 and microchannel chip 14 face each other in the present embodiment, but spacer 15 may be disposed only in a part of the region where reservoir 11 and microchannel chip 14 face each other.

The thickness of spacer 15 is not limited as long as first region 121 of cap 12 housed in pressing region 112a of opening 112 of reservoir 11 has a value with which cap 12 is not moved by the own weight of reservoir 11, an external impact or the like.

The material of spacer 15 is not limited as long as a sufficient gap between reservoir 11 and microchannel chip 14 can be maintained, and reservoir 11 or microchannel chip 14 is not damaged when spacer 15 is pulled out and the like. Examples of the material of spacer 15 include polyester such as polyethylene terephthalate; polycarbonate; acrylic resin such as polymethylmethacrylate; polyvinyl chloride; polyolefin such as polyethylene, polypropylene, and cycloolefin resin; polyether; and polystyrene resin material. In addition, spacer 15 can be formed by injection molding and the like, for example.

Note that fluid handling system 100 of the present embodiment may further include a supporting part and the like for supporting reservoir 11 such that the position with respect to microchannel chip 14 is not shifted and reservoir 11 is not detached from microchannel chip 14 after spacer 15 is removed from fluid handling system 100.

### Fluid Handling Method of First Embodiment

A fluid handling method using fluid handling system 100 of the embodiment is described below.

First, as illustrated in FIGS. 2A and 2B, opening 112 of reservoir 11 and the inlet of microchannel chip 14 are disposed opposite to each other. Then, one end of cap 12 is housed in pressing region 112a of opening 112 of reservoir 11. To be more specific, first region 121 of cap 12 is housed in pressing region 112a of reservoir 11 while being pressed toward its central axis CA along the minor axis direction of the rhombus from two directions (in FIG. 6A, the directions indicated by the arrow). On the other hand, protruding part 143 of microchannel chip 14 is fit to through hole 120 of the other end side of cap 12. It should be noted that in the state where fluid handling system 100 is in the closed state, protruding part 143 of microchannel chip 14 may not be fit into through hole 120 of cap 12, and protruding part 143 may be fit into through hole 120 when setting fluid handling device 100 to the opened state.

Then, spacer 15 is disposed between reservoir 11 and microchannel chip 14 so that cap 12 is not pushed into housing part 111 side of reservoir 11 by the own weight of reservoir 11.

As described above, in the state where fluid handling system 100 is set to the closed state, housing part 111 of reservoir 11 is filled with the desired fluid, and housing part 111 is closed with lid 13. Note that in the case where the above-described microchannel chip 14 is used, one of three housing parts 111 is filled with the sample, another one is filled with the reagent, and, remaining one is used for fluid collection, i.e., set to an empty state. It should be noted that depending on the application of microchannel chip 14, all housing parts 111 may be filled with the fluid. In addition, reservoir 11 in which each housing part 111 is filled with fluid (such as reagent and sample) in advance may be used.

In addition, the type of the fluid to be housed in housing part 111 of reservoir 11 is not limited as long as it can move to microchannel chip 14 side via through hole 120 of cap 12. The fluid may include a single component or a plurality of components. In addition, the fluid is not limited to liquid, and may be one in which a solid component is dispersed in a solvent, for example. In addition, it may be a fluid in which droplets (liquid droplets) and the like incompatible with the solvent are dispersed in a solvent.

When moving fluid from reservoir 11 to microchannel chip 14 side in the fluid handling system 100, spacer 15 is removed and first region 121 of cap 12 is pushed to open region 112b side of opening 112, as illustrated in FIGS. 3A, 3B and 9. Note that the own weight of reservoir 11 may be used for the method of pushing first region 121 of cap 12 to open region 112b side of reservoir 11. In addition, the user may push reservoir 11 downward in the gravity direction. Furthermore, microchannel chip 14 and reservoir 11 may be pushed against each other by sandwiching them by various devices. Through this operation, through hole 120 of cap 12 is opened, and fluid moves from housing part 111 side of reservoir 11 to inlet 141 side of microchannel chip 14.

Note that as necessary, a pressure may be applied to the inside of housing part 111 in which fluid is housed, and a particular housing part 111 may be suctioned in order to facilitate flow of the fluid in through hole 120 of cap 12.

### Modification of First Embodiment

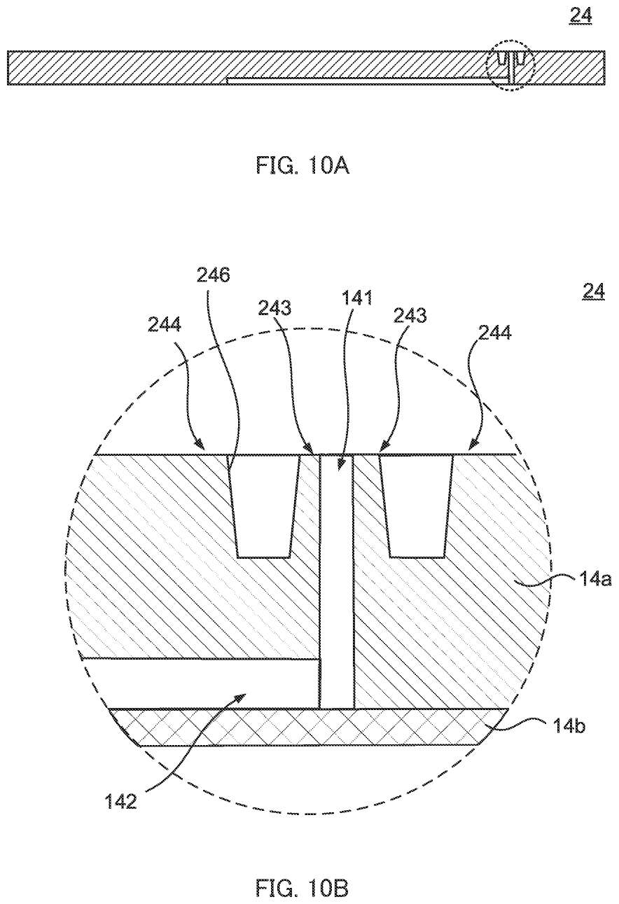

In the description above, each of protruding part 143 and guide part 144 of microchannel chip 14 is a circular protrusion protruded at the surface of microchannel chip 14 opposite to reservoir 11. It should be noted that protruding part 143 and guide part 144 may not be protruded at the surface of microchannel chip 14. FIG. 10A is a schematic sectional view of a modification of the microchannel chip of the first embodiment. In addition, FIG. 10B illustrates an enlarged view of the portion surrounded by the broken line in FIG. 10A. Note that the same configurations as those of the above-described microchannel chip 14 are denoted with the same reference numerals, and therefore the description thereof is omitted.

In microchannel chip 24 of the modification, circular groove 246 concentric with inlet 141 is provided in the surface of body part 14a opposite to reservoir 11. In the microchannel chip 24, the region between groove 246 and inlet 141 functions as protruding part 243. In addition, the region outside groove 246 functions as guide part 244. The width and/or depth of the groove 246 is not limited as long as when setting fluid handling system 100 to the opened state, protruding part 243 can be fit in through hole 120 of cap 12, and further, the end portion side of cap 12 can be fit between protruding part 243 and guide part 244.

In addition, in the description above, open region 112b of opening 112 of reservoir 11 is disposed on housing part 111 side of reservoir 11 than pressing region 112a of the opening 112. It should be noted that in opening 112 of reservoir 11, pressing region 112a may be disposed on housing part 111 side of reservoir 11 than open region 112b. In this case, fluid handling system 100 can be set to the opened state from the closed state by pulling cap 12 from housing part 111 side toward the outside, and moving first region 121 of cap 12 housed in pressing region 112a to open region 112b side. When setting fluid handling system 100 to the opened state, protruding part 143 of microchannel chip 14 is fit to through hole 120 of cap 12 as in the description above.

### Second Embodiment

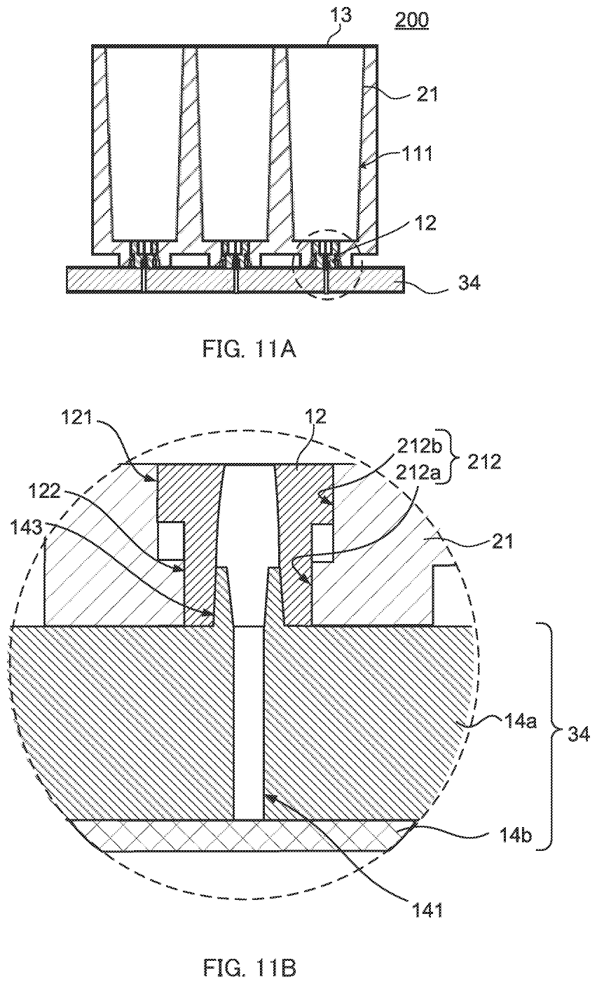

A fluid handling system according to a second embodiment of the present invention is described below. FIG. 11A is a schematic sectional view of the fluid handling system of the present embodiment, and FIG. 11B is a partially enlarged view of the region surrounded by the broken line in FIG. 11A. Note that FIGS. 11A and 11B illustrate an opened state of the fluid handling system 200 after the spacer is removed.

Fluid handling system 200 of the present embodiment includes reservoir 21 configured to house fluid, microchannel chip 34 disposed below the reservoir 21 in the gravity direction, a spacer (not illustrated) disposed between the reservoir 21 and microchannel chip 34, cap 12 including one end configured to be fit to an opening (not illustrated) of reservoir 21 and the other end configured to be connected to an inlet (not illustrated) of microchannel chip 34, and lid 13 configured to cover reservoir 11. Each configuration of the fluid handling system 200 is the same as that of the first embodiment except for the shape of the opening of reservoir 21 and the shape of microchannel chip 34. Therefore, the same components as those of the first embodiment are denoted with the same reference numerals, and the description thereof is omitted. In addition, also in the present embodiment, a spacer may not be provided as long as, when setting fluid handling system 200 to the closed state, a gap is provided between reservoir 21 and microchannel chip 34 and a situation where cap 12 is pushed to housing part 111 side of reservoir 21 can be suppressed.

As illustrated in FIG. 11B, microchannel chip 34 of the present embodiment includes inlet 141 configured to introduce the fluid, a channel (not illustrated) configured to carry the fluid introduced from inlet 141, an outlet configured to discharge the fluid (not illustrated), and protruding part 143 disposed to surround the opening edges of inlet 141 and the outlet. In addition, as illustrated in FIG. 11B, the microchannel chip 34 is composed of body part 14a and film 14b bonded to one surface of the body part. Microchannel chip 34 has the same structure as that of microchannel chip 14 of the first embodiment except that introduction part 144 is not provided.

On the other hand, reservoir 21 of the present embodiment includes housing part 111 and opening 212. Opening 212 includes pressing region 212a disposed on the outside in reservoir 21 and including opening with a substantially elliptical columnar shape, and open region 212b disposed on housing part 111 side in reservoir 21 and including an opening with a substantially columnar shape. In the present embodiment, the height of pressing region 212a is sufficiently smaller than the height of second region 122 of cap 12. On the other hand, the height of open region 212b is set to a height sufficiently greater than the height of first region 121 of cap 12. Note that the structure of reservoir 21 is the same as the structure of reservoir 11 of the first embodiment except that the height of open region 212b and pressing region 212a.

### Fluid Handling Method of Second Embodiment

A fluid handling method using fluid handling system 200 of the present embodiment is described below.

First, opening 212 of reservoir 21 and inlet 141 of microchannel chip 34 are disposed opposite to each other. Then, one end of cap 12 is housed in pressing region 212a of opening 212 of reservoir 21. On the other hand, protruding part 143 of microchannel chip 34 is fit in through hole 120 of the other end side of cap 12. It should be noted that fluid handling system 200 is in a closed state, protruding part 143 of microchannel chip 34 may not be fit in through hole 120 of cap 12, and protruding part 143 may be fit in through hole 120 when setting fluid handling device 200 to the opened state.

Further, spacer 15 is disposed between reservoir 21 and microchannel chip 34 so that cap 12 is not pushed to housing part 111 side of reservoir 21 by the own weight of reservoir 21.

Then, spacer 15 is removed, and first region 121 of cap 12 is moved into open region 212b of opening 212 of reservoir 21 as illustrated in FIG. 11B. At this time, also, reservoir 21 is moved to microchannel chip 34 side such that the end portion of cap 12 on microchannel chip 34 side is sandwiched between protruding part 143 of microchannel chip 34 and the inner wall of pressing region 212a of reservoir 21. By supporting cap 12 from the external side with the inner wall of pressing region 212a of reservoir 21, cap 12 becomes difficult to break and its blockage is easily suppressed. Note that the entirety of the outer periphery of the other end side of cap 12 may not be supported by the inner wall of pressing region 212a of reservoir 21, and a gap may be partially provided between the outer periphery of cap 12 and the inner wall of pressing region 212a of reservoir 21.

Here, the method of pushing reservoir 21 and microchannel chip 34 is not limited, and the own weight of reservoir 21 may be utilized, and the user may push reservoir 21 downward in the gravity direction. Microchannel chip 34 and reservoir 21 may be sandwiched by various devices.

Also in the present embodiment, as necessary, a pressure may be applied to housing part 111 in which fluid is housed, and a particular housing part 111 may be suctioned in order to facilitate the flow of the fluid in through hole 120 of cap 12.

### Effect

In each of the fluid handling system of the first embodiment and the fluid handling system of the second embodiment, the fluid can be moved from the reservoir side to the microchannel chip side by removing the spacer and pushing the cap to the reservoir side alone. In addition, by containing a plurality of liquids in the housing part, they may be simultaneously moved. Accordingly, without using large-scale apparatuses, the desired fluid can be supplied to the microchannel chip. That is, the fluid handling system is extremely useful also in terms of cost and task efficiency. In addition, with the fluid handling system, collection of the fluid to the reservoir and the like can be achieved, and inspection and analysis of various types of fluid can be efficiently performed.

In addition, in the above-described fluid handling system, the cap is pushed to the housing part side of the reservoir when setting the opened state. Therefore, in the opened state, the inner pressure in the housing part of the reservoir is increased, and the fluid housed in the housing part is easily discharged with the increased inner pressure.

In addition, in the above-described fluid handling system, when setting the opened state, the protruding part of the microchannel chip is fit in the through hole of the cap. Thus, the cap is less bent or crushed on the microchannel chip side, and the fluid can be stably moved from the housing part side of the reservoir to the inlet side of the microchannel chip.

Further, in the first embodiment, the other end side of the cap is sandwiched between the guide part and the protruding part of the microchannel chip. In addition, in the second embodiment, the other end side of the cap is sandwiched between the protruding part of the microchannel chip and the inner wall of the opening of the reservoir. Thus, during movement of the fluid, the cap is less removed, and the fluid can be reliably moved into the microchannel chip.

### Other Notes

In the first embodiment and the second embodiment, the opening of the reservoir has the pressing region and the open region, but the housing part may serve as the open region. In this case, when setting the fluid handling system to the closed state, the first region of the cap is housed in the pressing region of the opening. On the other hand, when setting the fluid handling system to the opened state, the first region of the cap is pushed into the housing part. In this manner, the pressing on the first region at the pressing region is released, and the fluid can move in the through hole of the cap.

In addition, in the description above, the reservoir has a substantially cuboid shape as an example, but the shape of the reservoir may be any shape such as a columnar shape and a bag shape, for example. Further, the position of the opening is not limited to the bottom portion of the reservoir, and for example, it may be disposed in a side surface on the bottom side in the reservoir.

In addition, in the description above, the cap in which two columns with different diameters are coupled is described, but the shape of the cap is not limited to the above-mentioned shape. For example, the cap may have a columnar-shaped structure with a uniform cross-sectional area from the first region to the second region. It should be noted that in this case, the opening diameter of the through hole of the first region is smaller than the opening diameter of the through hole of the second region. In addition, the cap may have a cone shape whose cross-sectional area continuously changes. In addition, the cap may have a structure composed of two contiguous rectangular prisms with different widths.

Further, it is possible to provide, at a position on the second region side of the cap, or at the reservoir, a stopper and the like for preventing further movement of the first region of the cap to the housing part side from the open region of the opening of the reservoir after the fluid handling system is set to the opened state.

In addition, in the description above, the channel chip is a microchannel chip as an example, but the channel chip may not be a microchannel chip, and may be larger than a microchannel chip.

This application is entitled to and claims the benefit of Japanese Patent Application No. 2018-226560 filed on Dec. 3, 2018, the disclosure each of which including the specification, drawings and abstract is incorporated herein by reference in its entirety.

### INDUSTRIAL APPLICABILITY

The fluid handling system of the embodiment of the present invention is applicable to various fluid inspections, analysis and the like, for example.

### REFERENCE SIGNS LIST

11, 21 Reservoir
12 Cap
13 Lid
14, 24, 34 Microchannel chip
14a Body part
14b Film
15 Spacer
100, 200 Fluid handling system
111 Housing part
112, 212 Opening
112a, 212a Pressing region
112b, 212b Open region
120 Through hole
121 First region
122 Second region
141 Inlet
141a First inlet
141b Second inlet
142 Channel
142a First groove part
142b Second groove part
142c Third groove part
143, 243 Protruding part
144, 244 Guide part
145 Outlet
246 Groove

1. A fluid handling system comprising:
a reservoir including a housing part configured to house fluid and an opening disposed in a side surface or a bottom surface of the housing part, the opening being configured to communicate between the housing part and outside;
a channel chip disposed opposite to the opening of the reservoir, the channel chip including an inlet configured to introduce the fluid, a channel configured to carry the fluid introduced from the inlet, and a protruding part disposed to surround an opening edge of the inlet; and
a cap made of a flexible elastomer and including one end configured to be fit into the opening of the reservoir, another end configured to be connected to the inlet of the channel chip, and a through hole configured to connect the one end and the other end,
wherein when the opening of the reservoir presses one end side of the cap such that the through hole is closed, a closed state is set, the closed state being a state where the fluid in the housing part does not move to outside through the through hole of the cap,
wherein when the one end side of the cap is moved from the closed state to a side of the housing part of the reservoir or to a side of the channel chip, pressing on the cap at the opening is released, and an opened state is set, the opened state being a state where the fluid moves to the side of the housing part of the reservoir toward the inlet of the channel chip through the through hole, and
wherein in the opened state, the protruding part of the channel chip is fit to the through hole on a side of the other end of the cap and suppresses closing of the through hole.

2. The fluid handling system according to claim 1, wherein the channel chip further includes a guide part configured to guide the other end of the cap to a side of the inlet on an outer periphery side of the protruding part.

3. The fluid handling system according to claim 1, wherein in the opened state, the other end of the cap is sandwiched between the protruding part of the channel chip and an inner wall of the opening of the reservoir.
